(19) United States
(12) Patent Application Publication
(10) Pub. No.: US 2025/0020312 A1
(43) Pub. Date: Jan. 16, 2025

(54) LIGHT SOURCE MODULE AND DISPLAY DEVICE

(71) Applicants: Asphetek Solution (Chengdu) Ltd., Sichuan (CN); Asphetek Solution Inc., Hsinchu (CN)

(72) Inventors: YING-HUNG TSAI, Hsinchu (TW); YEN-HENG HUANG, Hsinchu (TW); CHEN-LUNG FAN, Hsinchu (TW)

(21) Appl. No.: 18/235,637

(22) Filed: Aug. 18, 2023

(30) Foreign Application Priority Data
Jul. 13, 2023 (CN) 202310859511.8

(51) Int. Cl. F21V 9/20; F21V 5/02

(52) U.S. Cl. CPC F21V 9/20; F21V 5/02

(57) ABSTRACT

A light source module includes a first light source, a second light source, a combining component, and a transparent medium. The first light source emits a first light. The second light source emits a second light. The second light propagates along an optical path different from that of the first light. The combining component is on optical paths of the first light and the second light. The combining component combines the first light and the second light. The transparent medium fills a gap between the first light source and the combining component, and a gap between the second light source and the combining component. An absolute value of a difference in refractive index between the transparent medium and the combining component is less than an absolute value of a difference in refractive index between the air and the combining component.

### FIELD

The subject matter herein relates to a field of display technology, particularly relates to a light source module and a display device having the light source module.

### BACKGROUND

A light source module usually includes multiple optical components having different functions, and air fills gaps between these optical components. These optical components are usually made of glass, resin, and other media. When light propagates from one medium to another medium having different refractive indices, refraction occurs.

That is, light deviates at the interface of different medias, which means direction of light propagation change. Therefore, in the light source module, refraction occurs at the interface between the optical component and the air, resulting in distortion of the image generated when the light source module is used for display device imaging.

Therefore, there is room for improvement in the art.

### BRIEF DESCRIPTION OF THE DRAWINGS

Implementations of the present technology will now be described, by way of embodiments only, with reference to the attached figures.

FIG. 1 is a schematic view of a light source module according to an embodiment of the present disclosure.

FIG. 2 is an enlarged view of a portion X in FIG. 1.

FIG. 3 is a schematic view of a display device according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

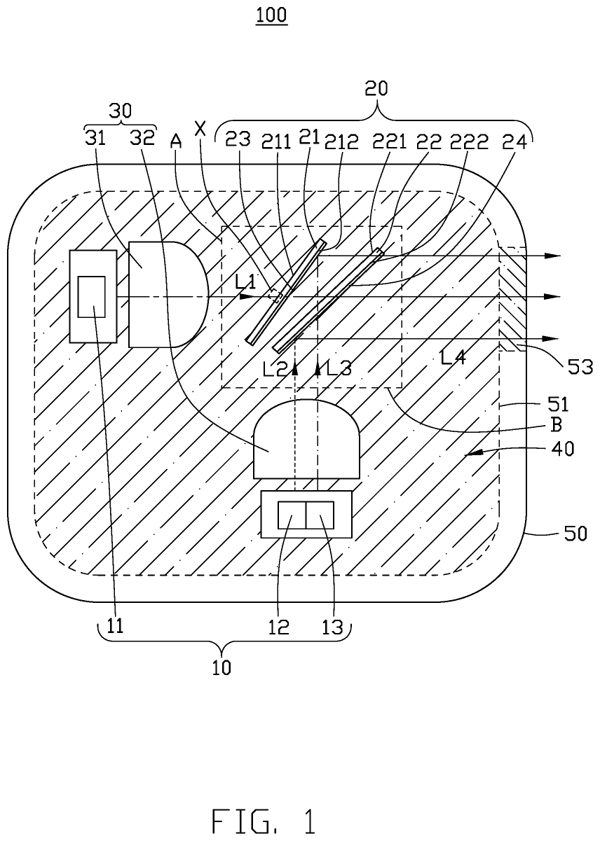

The present disclosure provides a light source module. As shown in FIG. 1, the light source module 100 includes a light-emitting component 10, a combining component 20, a collimating component 30, a transparent medium 40, and a sealed and hollow housing 50.

In this embodiment, the light-emitting component 10 includes a first light source 11, a second light source 12, and a third light source 13. The first light source 11 emits first light L1. The second light source 12 emits second light L2, which propagates along an optical path different from that of the first light L1. The third light source 13 is used to emit third light L3, which propagates along an optical path different from that of the first light L1 and the second light L2. FIG. 1 only shows one beam of light of the first light L1, the second light L2, and the third light L3, respectively. That is, optical paths of the first light L1, the second light L2, and the third light L3 are different from each other. Due to the different positions of the first light source 11, the second light source 12, and the third light source 13 in the light source module 100, the optical paths of the first light L1, the second light L2, and the third light L3 before reaching the combining component 20 are different.

In this embodiment, the light-emitting component 10 uses light-emitting diode (LED) as the light source, and the light-emitting component 10 includes a plurality of LEDs. The first light source 11, the second light source 12, and the third light source 13 each includes at least one LED. When applied to different products, sizes of LEDs vary. In addition to conventional sized LEDs, sub millimeter LEDs (mini LEDs) and micro LEDs (micro LEDs) can also be used.

In other embodiments, the light-emitting component 10 uses a laser as the light source, and the light-emitting component 10 includes a plurality of lasers. The first light source 11, the second light source 12, and the third light source 13 each include at least one laser.

In this embodiment, the combining component 20 includes a first prism 21 and a second prism 22. The first prism 21 includes an inlet surface 211 and an outlet surface 212. The second prism 22 includes an inlet surface 221 and an outlet surface 222, and the outlet surface 212 is opposite to the inlet surface 221. The combining component 20 includes a first side A and a second side B. The first light source 11 is located on the first side A of the combining component 20, and both the second light source 12 and the third light source 13 are located on the second side B of the combining component 20. Specifically, when the light-emitting component 10 emits light, the first light source 11 emits the first light L1 towards the inlet surface 211 of the first prism 21; the second light source 12 emits the second light L2 towards the outlet surface 222 of the second prism 22, and the third light source 13 emits the third light L3 towards the outlet surface 212 of the first prism 21. Before reaching the combining component 20, the optical path of the first light L1 is perpendicular to the optical path of the second light L2 and the optical path of the third light L3, and the optical path of the second light L2 and the optical path of the third light L3 are parallel to each other. The combining component 20 is arranged on the optical paths of the first light L1, the second light L2, and the third light L3. The combining component 20 is configured for transmitting or reflecting light, combining the first light L1, the second light L2, and the third light L3 to be a fourth light L4. The optical paths of the first light L1, the second light L2, and the third light L3 intersect and overlap to mix into the fourth light L4.

The first prism 21 transmits the first light L1 and reflects the third light L3. The second prism 22 transmits both the first light L1 and the third light L3, and reflects the second light L2. More specifically, the first light L1 emitted by the first light source 11 sequentially passes through the inlet surface 211 and outlet surface 212 of the first prism 21, and the inlet surface 221 and outlet surface 222 of the second prism 22. The second light L2 emitted by the second light source 12 is reflected by the outlet surface 222 of the second prism 22 and coincides with the optical path of the first light L1. The third light L3 emitted by the third light source 13 sequentially passes through the outlet surface 222 and inlet surface 221 of the second prism 22 and emits towards the outlet surface 212 of the first prism 21; then is reflected by the outlet surface 212 and coincides with the optical paths of the first light L1 and the second light L2. The first light L1, the second light L2, and the third light L3 combine to be the fourth light L4.

In this embodiment, the first light L1 is green light, the second light L2 is red light, and the third light L3 is blue light. Optionally, in other embodiments, one of the first light L1, the second light L2, and the third light L3 can be selected as green light, the other as red light and blue light. It can be concluded that the fourth light L4 is composed of red light, green light, and blue light mixed in a certain proportion of luminous flux to form white light. In other embodiments, it can also be of various light colors. In other words, the color of the fourth light L4 varies with the mixing ratio of the red light, the green light, and the blue light.

In this embodiment, the transparent medium 40 fills a gap between the light-emitting component 10 and the combining component 20. Specifically, the transparent medium 40 fills a gap between the first light source 11 and the first prism 21, a gap between the second light source 12 and the second prism 22, and a gap between the third light source 13 and the second prism 22. The transparent medium 40 also fills a gap between the first prism 21 and the second prism 22. More specifically, an absolute value of difference in refractive indexes between the transparent medium 40 and the combining component 20 is less than an absolute value of the difference in refractive indexes between the air medium (refractive index of 1) and the combining component 20. Optionally, the first prism 21 and the second prism 22 is made of glass or resin. Therefore, in order to make the refractive index of the transparent medium 40 to be similar to the refractive indices of the first prism 21 and the second prism 22 in the combining component 20, the refractive index of the transparent medium 40 is greater than 1, and has a range between 1.48 and 1.53. Optionally, the transparent medium 40 can be made of optical clear resin (OCR) or optical clear adhesive (OCA). Both OCR and OCA have high transmittance characteristics, and it can also be considered that the haze is as low as ideal. The refractive indices of the first prism 21 and the second prism 22 can be the same, but not limited to this.

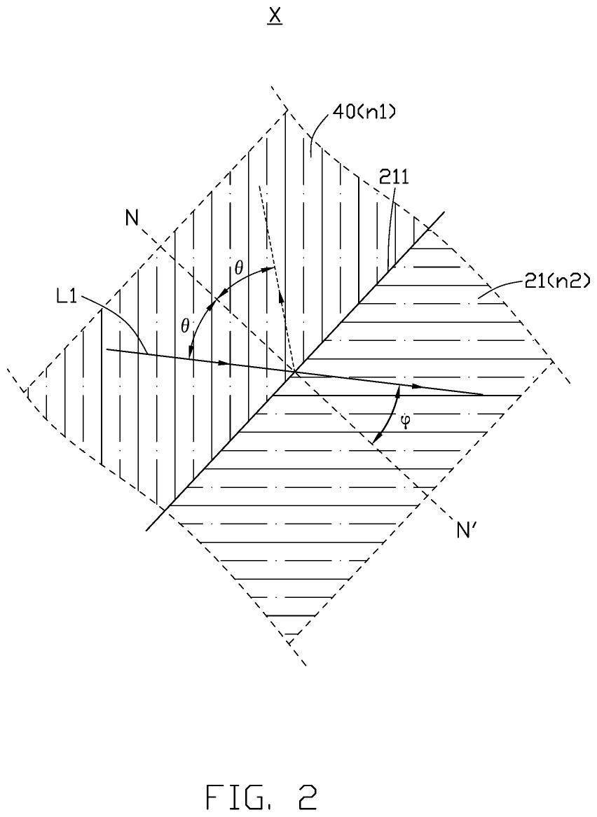

In theory, the less the absolute value of the difference in refractive index between the transparent medium 40 and the combining component 20, the less significant the refractive phenomenon that occurs when light propagates at the interface between the transparent medium 40 and the combining component 20. As shown in FIG. 2, when the first light L1 emitted by the first light source 11 is received by the first prism 21 through the transparent medium 40, the first light L1 penetrates the inlet surface 211 of the first prism 21, which is equivalent to the interface between the transparent medium 40 and the first prism 21. Assuming line N-N′ is the normal of the inlet surface 211, the refractive index of the transparent medium 40 is n1, the refractive index of the first prism 21 is n2, and both the incident angle θ and the exit angle φ are shown in FIG. 2, following formula (1) can be obtained according to Snell's Law.

$$\frac{sin θ}{sin φ} = \frac{n 2}{n 1} \qquad ( 1 )$$

According to formula (1), as n1 and n2 become closer in value, the closer the value of sin θ/sin φ tends towards 1, which indicates the less difference between the incident angle θ and the exit angle φ, the weaker the phenomenon of deflection of the optical path of the first light L1 due to refraction. When the value of n1/n2 infinitely approaches 1, the refractive index of the combing component 20 is equal to the refractive index of the transparent medium 40. According to formula (1), the value of sin θ/sin φ infinitely approaches 1, and propagation speed of the first light L1 in the transparent medium 40 and the first prism 21 is the same, and the incident angle θ and the exit angle φ are equal and opposite to each other, so the first light L1 does not reflect at the interface between the transparent medium 40 and the first prism 21. That is, the first light L1 does not refract at the interface between the transparent medium 40 and the first prism 21. The same applies when the first light L1 passes through the interface between the transparent medium 40 and the second prism 22, when the second light L2 and the third light L3 pass through the interface between the transparent medium 40 and the first prism 21, and when the second light L2 and the third light L3 pass through the interface between the transparent medium 40 and the second prism 22.

In addition, when the first light L1 propagates from the transparent medium 40 having a refractive index of n1 to the first prism 21 having a refractive index of n2 and penetrates into the inlet surface 211, both transmission and reflection occur.

In this embodiment, the first light L1 has no polarization state, so the first light L1 includes an equal amount of s-polarized light and p-polarized light. The polarization vector of the p-polarized light is parallel to the inlet surface 211, and the polarization vector of s-polarized light is perpendicular to the inlet surface 211. The reflectivity R of the first light L1 is equal to average of the reflectivity Rs of the s-polarized light and reflectivity Rp of the p-polarized light, and sum of the reflectivity R and transmittance T of the first light L1 is equal to 1. Following formulas (2) and (3) can be obtained.

$$R = \frac{Rs + Rp}{2} \qquad ( 2 )$$

$$T = 1 - R \qquad ( 3 )$$

According to the Fresnel's Formula, the relationship between the reflectivity Rs of the s-polarized light and the incident angle θ, the refractive index n1 and the refractive index n2 can be obtained as following formula (4); and the relationship between the reflectivity Rp of the p-polarized light and the incident angle θ, the refractive index n1 and the refractive index n2 can be obtained as following formula (5).

$$Rs = {[ \frac{n 1 cos θ - n 2 \sqrt{1 - {( \frac{n 1}{n 2} sin θ )}^{2}}}{n 1 cos θ + n 2 \sqrt{1 - {( \frac{n 1}{n 2} sin θ )}^{2}}} ]}^{2} \qquad ( 4 )$$

$$Rp = {[ \frac{n 1 \sqrt{1 - {( \frac{n 1}{n 2} sin θ )}^{2}} - n 2 cos θ}{n 1 \sqrt{1 - {( \frac{n 1}{n 2} sin θ )}^{2}} + n 2 cos θ} ]}^{2} \qquad ( 5 )$$

According to formulas (1) to (5), when the values of n1 and n2 are equal, following formulas can be obtained.

$$Rs = Rp = 0$$

$$R = 0 , T = 1$$

In summary, in this embodiment, the transmittance of the first light L1 when passing through the inlet surface 211 is 100% and the reflectivity of the first light L1 when passing through the inlet surface 211 is 0%. That is, when the first light L1 passes through the inlet surface 211, it only transmits and does not reflect by the inlet surface 211, which reduces light loss of the first light L1 for combining light. The same applies to the second light L2 and third light L3 when passing through the interface between the combining component 20 and the transparent medium 40.

In this embodiment, the combining component 20 further includes a first antireflection film 23 and a second antireflection film 24. The first antireflection film 23 is arranged on the outlet surface 212 of the first prism 21, and the second antireflection film 24 is arranged on the outlet surface 222 of the second prism 22. Specifically, the first antireflection film 23 is used to increase reflection of the third light L3 from the outlet surface 212, and the second antireflection film 24 is used to increase reflection of the second light L2 from the outlet surface 222. Optionally, when the third light L3 is blue light, the first antireflection film 23 is a blue light antireflection film. When the second light L2 is red light, the second antireflection film 24 is a red antireflection film.

In this embodiment, the collimating component 30 includes a first collimating mirror 31 and a second collimating mirror 32. The first collimating mirror 31 is between the first light source 11 and the first prism 21. The second collimating mirror 32 is between the second light source 12, the third light source 13, and the second prism 22. The collimating component 30 is used to collimate the light emitted by the light-emitting component 10, wherein the first collimating mirror 31 is used to collimate the first light L1, the second collimating mirror 32 is used to collimate the second light L2 and the third light L3.

The transparent medium 40 also fills a gap between the light-emitting component 10 and the collimating component 30, and a gap between the combining component 20 and the collimating component 30. Specifically, the transparent medium 40 fills a gap between the first collimating mirror 31 and the first light source 11, a gap between the second collimating mirror 32 and the second light source 12, a gap between the second collimating mirror 32 and the third light source 13, a gap between the first collimating mirror 31 and the first prism 21, and a gap between the second collimating mirror 32 and the second prism 22. The refractive index of the collimating component 30 is different from that of the transparent medium 40, so that the collimating component 30 embedded in the transparent medium 40 can still collimate light.

In this embodiment, the housing 50 defines a cavity 51, wherein the light-emitting component 10, the combining component 20, the collimating component 30, and the transparent medium 40 are all accommodated in the cavity 51. More specifically, the cavity 51 is completely filled with the light-emitting component 10, the combining component 20, the collimating component 30, and the transparent medium 40, without any air. Specifically, the transparent medium 40 also fills a gap between the first light source 11 and the housing 50, a gap between the second light source 12 and the housing 50, a gap between the third light source 13 and the housing 50, a gap between the combining component 20 and the housing 50, and a gap between the collimating component 30 and the housing 50.

In addition, the housing 50 also includes a light transmitting portion 53. The light transmitting portion 53 is made of a light transmitting material and is close to the outlet surface 222 of the second prism 22. The light transmitting portion 53 is used to allow the fourth light L4 to pass through. The fourth light L4 propagates from the outlet surface 222 of the second prism 22 to the light transmission portion 53, and shoots out beyond the housing 50.

In the light source module 100 in the present embodiment, the transparent medium 40 fills the gap between the first light source 11 and the combining component 20, the gap between the second light source 12 and the combining component 20, and the gap between the third light source 13 and the combining component 20. Moreover, the refractive index of the transparent medium 40 is closer to the combining component 20 compared to the air, which weakens the refraction phenomenon caused by differences in refractive indices between different media when the first light L1, the second light L2, and the third light L3 pass through the interface between the combining component 20 and the transparent medium 40, thereby improving imaging authenticity of display device using the light source module 100, making it widely applicable in display technology fields such as virtual reality and augmented reality.

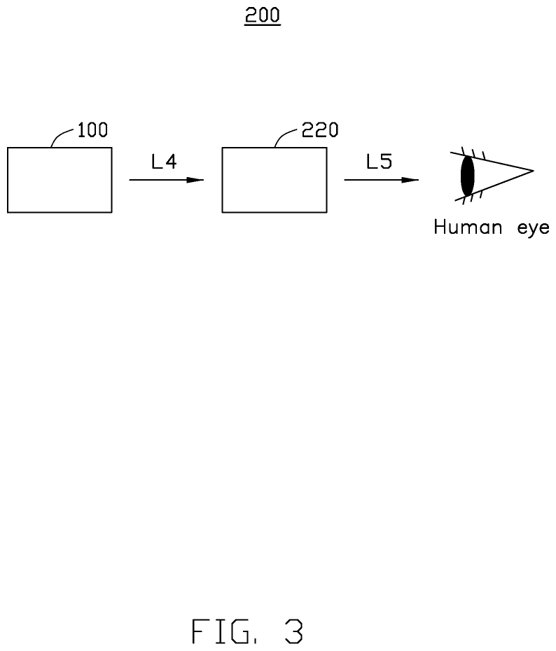

The present disclosure also provides a display device. As shown in FIG. 3, the display device 200 includes the above described light source module 100 and a dimming component 220. The light source module 100 is used to emit the fourth light L4. The dimming component 220 is on the optical path of the fourth light L4 and used to receive and adjust the fourth light L4, and convert the fourth light L4 into image light L5 for display.

The display device 200 can be a micro display, such as a transmissive liquid crystal display (LCD) and a reflective liquid crystal on silicon (LCOS) display; a display device using digital micromirror devices (DMD), and laser beam scanning (LBS) displays based on micro electro mechanical system (MEMS) technology, but not limited to these.

When the display device 200 is an LCD, the dimming component 220 includes optical components such as polarizers, filters, aspherical lenses, and liquid crystal molecular layers to adjust the physical properties of the fourth light L4 and convert the fourth light L4 into image light L5 for display. The image light L5 has image information.

Multiple display devices 200 are combined to form a near eye display system in augmented reality (AR) devices, but not limited to this. Specifically, each display device 200 uses at least one light source module 100 as the light source and projects the image light L5 into the human eye. One or more sets of image light L5 emitted by the display device 200 are combined into a virtual image and integrated into the real scene in the human eye by stacking.

In other embodiments, when the display device 200 is an LBS display, the first light source 11, the second light source 12, and the third light source 13 in the light source module 100 are RGB lasers, and the dimming component 220 includes MEMS.

The display device 200 utilizes the light source module 100 to emit light and combines advantages of filling the transparent medium 40 in the light source module 100 to improve refractive phenomena, thereby improving authenticity of the imaging of the display device 200, making it widely applicable in display technology fields such as virtual reality and augmented reality.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A light source module comprising:
a first light source configured for emitting a first light;
a second light source configured for emitting a second light, the second light propagating along an optical path different from an optical path of the first light;
a combining component on the optical paths of the first light and the second light, the combining component configured for combining the first light and the second light; and
a transparent medium filling a gap between the first light source and the combining component, and a gap between the second light source and the combining component,
wherein an absolute value of a difference between a refractive index of the transparent medium and a refractive index of the combining component is less than an absolute value of a difference between a refractive index of air and the refractive index of the combining component.

2. The light source module of claim 1, wherein the combining component is made of glass or resin, and the refractive index of the transparent medium is greater than 1.

3. The light source module of claim 2, wherein the refractive index of the transparent medium is in a range between 1.48 and 1.53.

4. The light source module of claim 1, further comprising a third light source for emitting a third light, wherein the third light propagates along an optical path different from the optical path of the first light and the optical path of the second light, the combining component is further arranged on the optical path of the third light and configured to combine the third light with the first light and the second light into a fourth light, and the transparent medium fills a gap between the third light source and the combining component.

5. The light source module of claim 4, wherein the combining component comprises a first side and a second side, the first light source is located on the first side, and the second light source and the third light source are located on the second side, and the first light source, the second light source, and the third light source are arranged such that the optical path of the first light is perpendicular to the optical path of the second light and the optical path of the third light, and the optical path of the second light and the optical path of the third light are parallel to each other.

6. The light source module of claim 5, wherein the combining component further comprises a first prism and a second prism, the first prism is configured to transmit the first light and reflect the third light, the second prism is configured to transmit each of the first light and the third light, and reflect the second light.

7. The light source module of claim 6, wherein the transparent medium further fills a gap between the first prism and the second prism.

8. The light source module of claim 6, further comprising a collimating component, wherein the collimating component comprises a first collimating mirror and a second collimating mirror, the first collimating mirror is between the first light source and the first prism, the second collimating mirror is between the second light source, the third light source, and the second prism, the first collimating mirror is configured to collimate the first light, the second collimating mirror is configured to collimate each of the second light and the third light.

9. The light source module of claim 8, wherein the transparent medium further fills a gap between the first collimating mirror and the first light source, a gap between the second collimating mirror and the second light source, a gap between the second collimating mirror and the third light source, a gap between the first collimating mirror and the first prism, and a gap between the second collimating mirror and the second prism.

10. The light source module of claim 8, further comprising a housing, wherein the housing defines a cavity, each of the first light source, the second light source, the third light source, the combining component, the collimating component, and the transparent medium is accommodated in the cavity, the transparent medium further fills a gap between the first light source and the housing, a gap between the second light source and the housing, a gap between the third light source and the housing, a gap between the combining component and the housing, and a gap between the collimating component and the housing.

11. A display device comprising:
a light source module, the light source module comprising:
a first light source configured for emitting a first light;
a second light source configured for emitting a second light, the second light propagating along an optical path different from an optical path of the first light;
a combining component on the optical paths of the first light and the second light, the combining component configured for combining the first light and the second light; and
a transparent medium filling a gap between the first light source and the combining component, and a gap between the second light source and the combining component, and
a dimming component, the dimming component on an optical path of light from the light source module and used to receive and covert the light into an image light for a display; wherein an absolute value of a difference between a refractive index of the transparent medium and a refractive index of the combining component is less than an absolute value of a difference between a refractive index of air and the refractive index of the combining component.

12. The display device of claim 11, wherein the combining component is made of glass or resin, and the refractive index of the transparent medium is greater than 1.

13. The display device of claim 12, wherein the refractive index of the transparent medium is in a range between 1.48 and 1.53.

14. The display device of claim 11, further comprising a third light source for emitting a third light, wherein the third light propagates along an optical path different from the optical path of the first light and the optical path of the second light, the combining component is further arranged on the optical path of the third light and configured to combine the third light with the first light and the second light into a fourth light, and the transparent medium fills a gap between the third light source and the combining component.

15. The display device of claim 14, wherein the combining component comprises a first side and a second side, the first light source is located on the first side, and the second light source and the third light source are located on the second side, and the first light source, the second light source, and the third light source are arranged such that the optical path of the first light is perpendicular to the optical path of the second light and the optical path of the third light, and the optical path of the second light and the optical path of the third light are parallel to each other.

16. The display device of claim 15, wherein the combining component further comprises a first prism and a second prism, the first prism is configured to transmit the first light and reflect the third light, the second prism is configured to transmit each of the first light and the third light, and reflect the second light.

17. The display device of claim 16, wherein the transparent medium further fills a gap between the first prism and the second prism.

18. The display device of claim 16, further comprising a collimating component, wherein the collimating component comprises a first collimating mirror and a second collimating mirror, the first collimating mirror is between the first light source and the first prism, the second collimating mirror is between the second light source, the third light source and the second prism, the first collimating mirror is configured to collimate the first light, the second collimating mirror is configured to collimate each of the second light and the third light.

19. The display device of claim 18, wherein the transparent medium further fills a gap between the first collimating mirror and the first light source, a gap between the second collimating mirror and the second light source, a gap between the second collimating mirror and the third light source, a gap between the first collimating mirror and the first prism, and a gap between the second collimating mirror and the second prism.

20. The display device of claim 18, further comprising a housing, wherein the housing defines a cavity, each of the first light source, the second light source, the third light source, the combining component, the collimating component, and the transparent medium is accommodated in the cavity, the transparent medium also fills a gap between the first light source and the housing, a gap between the second light source and the housing, a gap between the third light source and the housing, a gap between the combining component and the housing, and a gap between the collimating component and the housing.
